(19) United States
(12) Patent Application Publication
(10) Pub. No.: US 2026/0110780 A1
(43) Pub. Date: Apr. 23, 2026

(54) OPTOELECTRONIC SENSOR

(71) Applicant: SICK AG, Waldkirch (DE)

(72) Inventor: ARMIN WERBER, Teningen (DE)

(21) Appl. No.: 19/356,517

(22) Filed: Oct. 13, 2025

(30) Foreign Application Priority Data
Oct. 14, 2024 (DE) 102024129621.6

(51) Int. Cl. G01S 7/481; G01S 17/42

(52) U.S. Cl. CPC G01S 7/4817; G01S 17/42

(57) ABSTRACT

An optoelectronic sensor comprises at least one light transmitter for transmitting a transmission light beam, a light receiver for receiving reception light and a scanning device that defines a transmission light path and a reception light path. The scanning device comprises a first mirror that is designed as a first rotating mirror, that is arranged in the transmission light path and that can be driven in a rotating manner about an axis of rotation in order to periodically deflect the transmission light beam within a first scanning plane; a second mirror that is designed as a second rotating mirror, that is arranged in the reception light path and that can be driven in a rotating manner about the axis of rotation synchronously to the first rotating mirror; and a third mirror that is arranged in the transmission light path, that is designed as a tilting mirror and that can be driven in a tilting manner about a tilting axis oriented transversely to the axis of rotation in order to deflect the transmission light beam within a second scanning plane extending transversely to the first scanning plane.

The invention relates to an optoelectronic sensor comprising at least one light transmitter for transmitting a transmission light beam, a light receiver for receiving reception light and a scanning device for scanning a monitored zone by means of a variable light deflection, wherein the scanning device defines a transmission light beam and a reception light path and wherein the scanning device comprises a first mirror that is designed as a first rotating mirror, that is arranged in the transmission light path and that can be driven in a rotating manner about an axis of rotation in order to periodically deflect the transmission light beam within a first scanning plane.

Such sensors are, for example, used to monitor hazardous regions or to recognize objects. The rotating mirror being rotated ensures that the transmission light beam sweeps over a certain angular range and thereby spans the first scanning plane. For this purpose, the rotating mirror is preferably driven by a motor at a constant rotational speed.

In certain applications, the monitoring within a single defined scanning plane is not sufficient. For such applications, multilayer scanners or three-dimensional scanners must be used. Known sensors of this kind have a complex structure and are correspondingly expensive.

It is an object of the invention to provide an optoelectronic sensor of the aforementioned kind that enables a monitoring beyond the first scanning plane and nevertheless has a simple structure.

The object is satisfied by an optoelectronic sensor having the features of Claim 1.

According to the invention, the optoelectronic sensor comprises a second mirror that is designed as a second rotating mirror, that is arranged in the reception light path and that can be driven in a rotating manner about the axis of rotation synchronously to the first rotating mirror; and a third mirror that is arranged in the transmission light path, that is designed as a tilting mirror and that can be driven in a tilting manner about a tilting axis oriented transversely to the axis of rotation in order to deflect the transmission light beam within a second scanning plane extending transversely to the first scanning plane.

Due to the tilting mirror, it is possible to adjust the scanning plane defined by the sensor, to provide an arrangement of a plurality of scanning planes or to span a three-dimensional scanning space.

The effort for producing an optoelectronic sensor according to the invention is reduced insofar as, for example, an existing biaxially designed two-dimensional LIDAR sensor (LIDAR stands for Light Detection and Ranging) with a single scanning plane can easily be extended to form a three-dimensionally scanning sensor by adding the second rotating mirror and the tilting mirror. The arrangement of the light transmitter and the light receiver as well as the signal evaluation and the communication interface do not need to be changed for this purpose.

One advantage of the separate design of the two rotating mirrors is that the transmission light and the reception light can be easily separated from one another, if necessary, by providing a shielding wall between the two rotating mirrors, whereby scattered light effects and unwanted crosstalk are counteracted. Although a three-dimensional scanning is possible, a further complex rotary drive for the light transmitter and/or the light receiver is not necessary. Thus, an optoelectronic sensor according to the invention has a particularly compact and simple mechanical structure.

Since the transmission light path and the reception light path extend coaxially in the mirror region, a particularly precise scanning is ensured.

The first rotating mirror and the second rotating mirror preferably each have planar reflection surfaces whose surface normals diverge.

Preferably, the tilting mirror can be driven to perform an oscillating movement in order to deflect the transmission light beam within the second scanning plane. A three-dimensional monitored zone can be scanned by a respective periodic deflection in two scanning planes extending at right angles to one another.

Preferably, the tilting mirror is a MEMS mirror, wherein the term “MEMS” refers to a micro-electromechanical system. Such mirrors have a comparatively high positioning speed and a relatively low energy consumption. MEMS mirrors are also characterized by a long service life.

In a preferred embodiment, the axis of rotation intersects the tilting axis, preferably at a right angle.

Provision can be made that the scanning device comprises a motor comprising a motor shaft that is drive-effectively coupled to both the first rotating mirror and the second rotating mirror. Thus, no additional synchronization mechanism is required since both rotating mirrors are driven by the same shaft. Furthermore, it is not necessary to provide two separate motors with a corresponding control for the two rotating mirrors.

According to one embodiment of the invention, the motor comprises a motor housing from which the motor shaft projects at both sides, wherein the first rotating mirror and the second rotating mirror are fixed at opposite end regions of the motor shaft. This enables a particularly simple and compact design.

In a preferred embodiment, the first rotating mirror and the second rotating mirror are supported at a common mirror holder. An additional holder for the second rotating mirror can thus be saved.

A specific embodiment of the invention provides that the light transmitter and the light receiver are integrated into a common optics module and in that at least one section of the common mirror holder is arranged between the tilting mirror and the common optics module. The beam deflection transverse to the first scanning plane takes place remote from the optics module that therefore does not need to be adjusted or driven.

A further embodiment of the invention provides that the light transmitter has a main radiation direction extending parallel to the axis of rotation and at a distance therefrom and that the scanning device has a deflection mirror that is configured and arranged to deflect the transmission light beam towards the tilting mirror arranged in the region of the axis of rotation. With such a design, the transmission light beam can be guided past the two rotating mirrors if the distance of transmission light beam from the axis of rotation is sufficiently large. Said transmission light beam is then deflected towards the tilting mirror, which is located behind the rotating mirrors, by means of the deflection mirror.

According to another embodiment, the optoelectronic sensor can comprise an optical waveguide that guides the transmission light beam from the light transmitter up to the tilting mirror. In this design, an additional deflection mirror can be dispensed with. Furthermore, the position of the light transmitter is variable.

The optical waveguide is preferably flexible. For example, an optical fiber composed of quartz glass or plastic, in particular a multimode fiber, can be provided as the optical waveguide.

The optoelectronic sensor can have an angle measurement device for detecting the current tilt angle of the tilting mirror. The detected tilt angle can then be considered, for example, when controlling and evaluating the sensor. The angle measurement device can, for example, comprise a diffraction grating which is arranged at the tilting mirror and by means of which a part of the transmission light beam, for example one diffraction order or a plurality of diffraction orders, is directed onto a light receiver such as a spatially resolving photodiode. A piezoresistive angle measurement device can generally also be provided.

Preferably, the optoelectronic sensor is a safety sensor that is configured for the recognition of objects in a safety field using fail-safe elements, in particular for the fail-safe inspection of the position of the tilt seal. In particular in the case of safety sensors, due to an additional scanning dimension, considerably extended application possibilities additionally result. Furthermore, a compact and cost-effective design, such as is made possible by the invention, is particularly important for safety sensors.

The optoelectronic sensor can have an electronic control device that is in signal connection with the light transmitter and with the light receiver and that is configured to determine the distance of an object located in the monitored zone on the basis of a detected time of flight.

In particular, the optoelectronic sensor can be designed as a LIDAR sensor, wherein LIDAR stands for “Light Detection and Ranging”. Such sensors are suitable in a variety of ways for the recognition of objects, persons or obstacles in monitored zones.

The electronic control device can be configured to monitor the monitored zone in three spatial directions at least in a 3D operating mode.

In some application situations, a continuous monitoring in all three spatial directions is not absolutely necessary. Accordingly, the electronic control device can be configured, at least in a corrected 2D mode, to monitor the monitored zone only within the first scanning plane and to perform an adjustment of the first scanning plane as required by means of the tilting mirror. This, for example, enables an active tracking of the transmission light beam to prevent it from being incident on the ground, which is particularly favorable for mobile applications on uneven ground, for example in agricultural engineering applications.

Further developments of the invention can also be seen from the dependent Claims, from the description and from the enclosed drawings.

The invention will be described in the following by way of example with reference to the drawings.

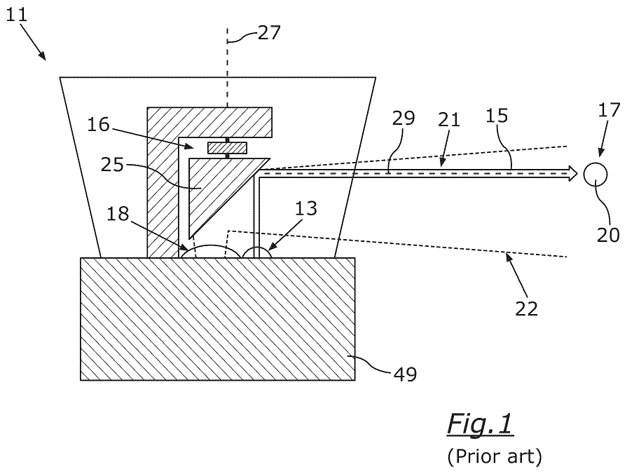

FIG. 1 shows, in a simplified form, an optoelectronic sensor designed according to the prior art;

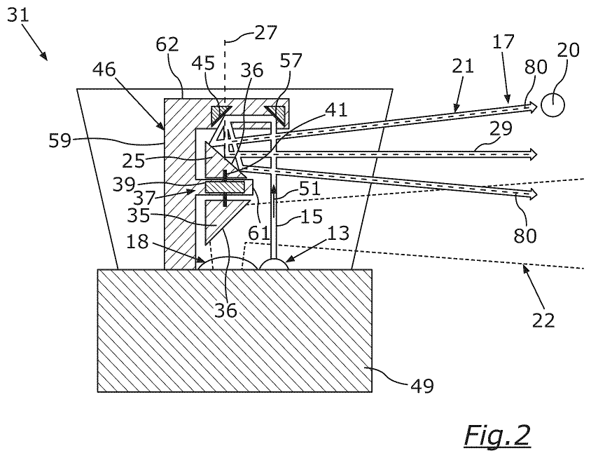

FIG. 2 shows an optoelectronic sensor according to a first embodiment of the invention; and

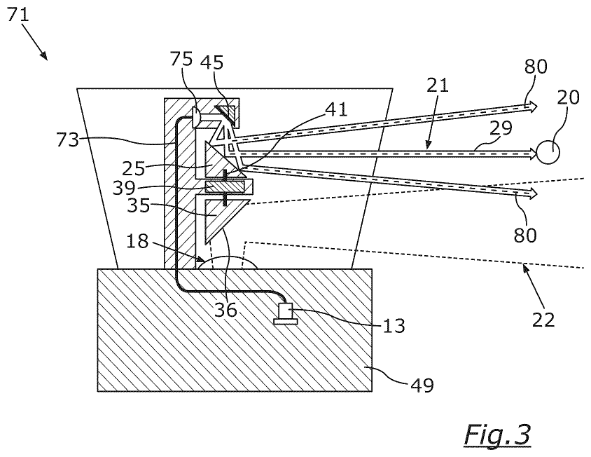

FIG. 3 shows an optoelectronic sensor according to a second embodiment of the invention.

The optoelectronic sensor 11 shown in FIG. 1, which is designed according to the prior art, comprises a light transmitter 13, for example in the form of a laser diode, that transmits a transmission light beam 15 during the operation of the optoelectronic sensor 11. The transmission light beam 15 is periodically deflected in a generally known manner by means of a scanning device 16 in order to scan a monitored zone 17. The optoelectronic sensor 11 furthermore comprises a light receiver 18 for receiving reception light. The light receiver 18 can, for example, be a photodiode. A transmission light path 21 of the optoelectronic sensor 11 is defined by the path of the transmission light beam 15 from the light transmitter 13 up to an object 20 within the monitored zone 17. On the other hand, a reception light path 22 is defined by the light path from the object 20 up to the light receiver 18. This is a biaxial arrangement.

The scanning device 16 comprises a first mirror in the form of a first rotating mirror 25 that is arranged in the transmission light path 21 and that can be driven in a rotating manner about an axis of rotation 27. As shown, the transmission light beam 15 transmitted by the light transmitter 13 is incident on the first rotating mirror 25 and is periodically deflected due to its rotation within a first scanning plane 29 that is horizontal in FIG. 1.

In the optoelectronic sensor 11 shown in FIG. 1, the monitored zone 17 is limited to a single plane, namely the first scanning plane 29.

In contrast, the optoelectronic sensor 31 shown in FIG. 2, which is designed according to a first embodiment of the invention, enables a spatially extended monitoring by means of a multilayer or three-dimensional scanning device 46. For this purpose, the optoelectronic sensor 31 according to the invention is provided with a second mirror that is separate from the first rotating mirror 25, namely a second rotating mirror 35, and that is arranged in the reception light path 22. With regard to the light transmitter 13, the light receiver 18 and the first rotating mirror 25 that can be driven in a rotating manner, the optoelectronic sensor 31 according to the invention is designed like the optoelectronic sensor 11 shown in FIG. 1, apart from the fact that the first rotating mirror 25, as shown, is driven from below instead of from above.

The first rotating mirror 25 and the second rotating mirror 35 have respective planar reflection surfaces 36 that, as shown, extend at right angles to one another and face away from one another. Furthermore, the first rotating mirror 25 and the second rotating mirror 35 are supported at a common mirror holder 37. Specifically, a motor 39 comprising a motor shaft 41 projecting at both sides is fastened to the mirror holder 37. The first rotating mirror 25 and the second rotating mirror 35 are fixed to opposite end regions of the motor shaft 41 as shown. A common axis of rotation 27 for both rotating mirrors 25, 35 is defined by the axis of the motor shaft 41. The motor 39 is preferably designed as an electric motor.

A tilting mirror 45 in the transmission light path 21 is located facing the reflection surface 36 of the first rotating mirror 25. The tilting mirror 45 is configured as a MEMS mirror and can be driven in a tilting manner about a tilting axis (not shown) oriented transversely to the axis of rotation 27. The axis of rotation 27 preferably intersects the tilting axis at a right angle.

The light transmitter 13 and the light receiver 18 are arranged next to one another and are integrated into a common optics module 49. As shown, the motor 39 comprising the first rotating mirror 25 and the second rotating mirror 35 is located between the tilting mirror 45 and the optics module 49. The light transmitter 13 has a main radiation direction 51 and is arranged on the optics module 49 such that the main radiation direction 51 extends parallel to the axis of rotation 27 and at a sufficient distance therefrom so that the transmission light beam 15 is not incident on the second rotating mirror 35. After the transmission light beam 15 has laterally passed the second rotating mirror 35 and the first rotating mirror 25, it is deflected by a preferably fixed deflection mirror 57 towards the tilting mirror 45. The transmission light beam 15 then passes from the tilting mirror 45 to the first rotating mirror 25.

The optoelectronic sensor 31 has an electronic control device, not shown separately, that can be integrated into the optics module 49, for example. During the sensor operation, said electronic control device controls the motor 39 and the drive of the tilting mirror 45. Furthermore, the electronic control device is configured to determine the distance of objects 20 in the monitored zone 17 based on a detected time of flight and to assign said distance to respective scanning positions, for example according to the LIDAR principle.

According to one embodiment of the invention, the tilting mirror 45 can be driven to perform an oscillating movement and the electronic control device ensures a periodic deflection of the transmission light beam 15 in a second scanning plane that extends vertically in FIG. 2. Due to the double periodic deflection in different directions, the monitored zone 17 can be scanned in all three spatial directions. Alternatively, the electronic control device can also be configured to only monitor the monitored zone 17 within the first scanning plane 29 and to only perform an adjustment of the first scanning plane 29 as required by means of the tilting mirror 45, as is illustrated in FIG. 2 by tilted scanning planes 80. For example, in mobile applications, the first scanning plane 29 can be adjusted upwards to prevent it from being incident on the ground. It is generally also possible that the optoelectronic sensor 31 according to the invention can be selectively operated in a three-dimensional scanning mode or in a mode with an adjustable individual scanning plane 29.

The mirror holder 37 is preferably attached directly to the optics module 49. As shown, the mirror holder 37 comprises a longitudinal member 59 from which a first cross member 61 and a second cross member 62 project. The motor 39 is fastened to the first cross member 61, while the tilting mirror 45 and the deflection mirror 57 are fastened to the second cross member 62.

The deflection mirror 57 can be dispensed with if a flexible light guide element is used. Such an embodiment of an optoelectronic sensor 71 according to the invention is shown in FIG. 3. An optical waveguide 73 comprising a collimation optics 75 at the output side ensures that the light is guided from the light transmitter 13 up to the tilting mirror 45. In principle, the light transmitter 13 can be positioned in any desired manner at the optics module 49 or even away from it.

Preferably, an angle measurement device is integrated in the tilting mirror 45 to detect the current tilting angle, which is not specifically shown in FIGS. 2 and 3, however. Such an angle measurement device ensures that the electronic control device always knows the current tilt angle. For example, such an angle measurement device can comprise a diffraction grating which is arranged at the tilting mirror 45 and by means of which one diffraction order or a plurality of diffraction orders of the incident light are directed onto a spatially resolving photodiode.

The invention, with a simple design and an inexpensive production, enables the monitoring of safety zones by means of LIDAR or similar mechanisms in different planes or in a three-dimensional region.

### REFERENCE NUMERAL LIST

11 optoelectronic sensor
13 light transmitter
15 transmission light beam
16 scanning device
17 monitored zone
18 light receiver
20 object
21 transmission light path
22 reception light path
25 first rotating mirror
27 axis of rotation
29 first scanning plane
31 optoelectronic sensor
35 second rotating mirror
36 reflection surface
37 mirror holder
39 motor
41 motor shaft
45 tilting mirror
46 scanning device
49 optics module
51 main radiation direction
57 deflection mirror
59 longitudinal member
61 first cross member
62 second cross member
71 optoelectronic sensor
73 optical waveguide
75 collimation optics
80 tilted scanning plane

1. An optoelectronic sensor comprising
at least one light transmitter for transmitting a transmission light beam, a light receiver for receiving reception light and a scanning device for scanning a monitored zone by means of a variable light deflection, wherein the scanning device defines a transmission light beam and a reception light path and wherein the scanning device comprises:
a first mirror that is designed as a first rotating mirror, that is arranged in the transmission light path and that can be driven in a rotating manner about an axis of rotation in order to periodically deflect the transmission light beam within a first scanning plane;
a second mirror that is designed as a second rotating mirror, that is arranged in the reception light path and that can be driven in a rotating manner about the axis of rotation synchronously to the first rotating mirror; and
a third mirror that is arranged in the transmission light path, that is designed as a tilting mirror and that can be driven in a tilting manner about a tilting axis oriented transversely to the axis of rotation in order to deflect the transmission light beam within a second scanning plane extending transversely to the first scanning plane.

2. The optoelectronic sensor according to claim 1,
wherein the tilting mirror can be driven to perform an oscillating movement in order to deflect the transmission light beam within the second scanning plane.

3. The optoelectronic sensor according to claim 1,
wherein the tilting mirror is a MEMS mirror.

4. The optoelectronic sensor according to claim 1,
wherein the axis of rotation intersects the tilting axis.

5. The optoelectronic sensor according to claim 4,
wherein the axis of rotation intersects the tilting axis at a right angle.

6. The optoelectronic sensor according to claim 1,
wherein the scanning device comprises a motor comprising a motor shaft,
wherein the motor shaft is drive-effectively coupled to both the first rotating mirror and the second rotating mirror.

7. The optoelectronic sensor according to claim 6,
wherein the motor comprises a motor housing from which the motor shaft projects at both sides, wherein the first rotating mirror and the second rotating mirror are fixed at opposite end regions of the motor shaft.

8. The optoelectronic sensor according to claim 1,
wherein the first rotating mirror and the second rotating mirror are supported at a common mirror holder.

9. The optoelectronic sensor according to claim 8,
wherein the light transmitter and the light receiver are integrated into a common optics module and wherein at least one section of the common mirror holder is arranged between the tilting mirror and the common optics module.

10. The optoelectronic sensor according to claim 1,
wherein the light transmitter has a main radiation direction extending parallel to the axis of rotation and at a distance therefrom and the scanning device has a deflection mirror that is configured and arranged to deflect the transmission light beam towards the tilting mirror arranged in the region of the axis of rotation.

11. The optoelectronic sensor according to claim 1,
wherein the optoelectronic sensor comprises an optical waveguide that guides the transmission light beam from the light transmitter up to the tilting mirror.

12. The optoelectronic sensor according to claim 1,
wherein the optoelectronic sensor has an angle measurement device for detecting the current tilt angle of the tilting mirror.

13. The optoelectronic sensor according to claim 1,
wherein the optoelectronic sensor is a safety sensor that is configured to recognize objects in a safety field to be monitored.

14. The optoelectronic sensor according to claim 1,
wherein the optoelectronic sensor has an electronic control device that is in signal connection with the light transmitter and with the light receiver and that is configured to determine the distance of an object located in the monitored zone on the basis of a detected time of flight.

15. The optoelectronic sensor according to claim 14,
wherein the electronic control device is configured to monitor the monitored zone in three spatial directions at least in a 3D operating mode.

16. The optoelectronic sensor according to claim 14,
wherein the electronic control device is configured, at least in a corrected 2D mode, to monitor the monitored zone only within the first scanning plane and to perform an adjustment of the first scanning plane as required by means of the tilting mirror.
